(19) United States
(12) Patent Application Publication
(10) Pub. No.: US 2025/0100170 A1
(43) Pub. Date: Mar. 27, 2025

(54) Method and Device for Providing Structured Indications of Noise Emissions from an Industrial Robot

(71) Applicant: ABB Schweiz AG, Baden (CH)

(72) Inventors: Johan Ernlund, Västerås (SE); Roger Mellander, Västerås (SE)

(21) Appl. No.: 18/729,926

(22) PCT Filed: Jan. 31, 2022
(86) PCT No.: PCT/EP2022/052224

§ 371 Date: Jul. 18, 2024

(51) Int. Cl. B25J 19/06

(52) U.S. Cl. CPC B25J 19/061

(57) ABSTRACT

A method of indicating noise emissions of an industrial robot, including: obtaining at least one robot program containing commands to the industrial robot; obtaining a plurality of values of at least one robot-motion parameter; recording, for each of the values of the robot-motion parameter, an acoustic quantity indicative of noise emitted by the industrial robot while executing said at least one robot program; and displaying, by means of a graphical user interface on a visual display, a visualization of the acoustic quantity indicated as a function of the robot-motion parameter.

### TECHNICAL FIELD

The present disclosure relates to design tools specialized for developing industrial robotic equipment. In particular, it presents methods and devices for providing structured indications of the noise emissions from an industrial robot.

### BACKGROUND

The process of developing an industrial robot up to the stage where it is ready to perform a useful processing or manufacturing task typically includes multiple successive stages and contributions by multiple actors. For example, while the basic mechanical and electric design is carried out by the robot manufacturer, the operating system, basic system configuration and basic applications may be developed by software specialists, whereas so-called integration is oftentimes entrusted to an integrator, an entity that could be neither the manufacturer nor the end user. The integration may include hardware- and software-related adaptations that render the robot fit for its future role.

For development aspects such as robot programming, setting of robot control parameters, placement of surrounding equipment and establishment of operator spaces, the ability to provide and exchange precise and reliable visual indications about the noise emitted by the robot is of high value. This applies regardless of whether the noise indications have been obtained through measurements, simulations, hybrid approaches, or have been received from another organization. An industrial robot may be performing a large number of tasks and movements, the robot might be configured for this using multiple parameters, and there could be significant interactions among these. As a result, the variability of the robot's emitted noise could be of high complexity and multi-dimensional. It appears that none of the interfaces for experiencing robots, including the immersive interface disclosed in US20190283248A1, would be fit to convey noise-related information with the preciseness and reliability necessary to support industrial robot development. This means robot development is still highly dependent on costly and time-consuming real-world testing, in a workshop or factory environment.

### SUMMARY

One objective of the present disclosure is to propose methods and devices for providing indications of noise emissions of an industrial robot suitable for supporting the development of such a robot. Another objective is to provide such methods and devices that support the tuning of parameters of the industrial robot. In particular, it is desirable for the methods and devices to provide the noise indications in such manner that parameters relating to multiple interacting robot subsystems (e.g., robot joints belonging to the same kinematic chain) can be harmonized with one another. A further objective is to make it possible to conduct a larger portion of a robot design or robot integration process offline. This could reduce the necessary amount of real-world testing, ultimately to control cost and total calendar time spent on the development of each robot.

At least some of these objectives are achieved by the present invention as defined by the independent claims. The dependent claims relate to advantageous embodiments of the invention.

In one aspect of the present invention, there is provided a method of indicating noise emissions of an industrial robot. The method comprises: obtaining at least one robot program containing command to the industrial robot; obtaining a plurality of values of at least one robot-motion parameter; recording, for each of the values of the robot-motion parameter, an acoustic quantity indicative of noise emitted by the industrial robot while executing said at least one robot program; and displaying, by means of a graphical user interface, a visualization of the acoustic quantity. According to the first aspect, the visualization indicates the acoustic quantity as a function of the robot-motion parameter.

Advantageously, the first aspect of the invention makes it possible to provide indications of the emitted noise of the industrial robot that are structured with respect to the robot-motion parameter(s). Unlike prior art interfaces where acoustical quantities are visualized as aggregates, this enables the operator to grasp the dependence on the robot-motion parameter(s) properly and use it as a basis for well-informed decisions in the onward robot development process. Thus, in comparison with known interfaces of this type, the method according to the first aspect enables the visualization of hitherto unseen information that reflects a condition prevailing in the industrial robot.

In the present disclosure, a “command” is a specific instruction to the industrial robot that is sufficient on its own to cause the robot to perform a well-defined action, such as a movement, processing step or self-maintenance action. The manner in which the industrial robot executes a command is dependent on the values of one or more of the “robot-motion parameters”. The robot-motion parameters may be considered as modifiers of the actions triggered by the commands. The assigning of a value to one of the robot-motion parameters on its own generally does not cause the robot to perform any action. A robot-motion parameter can be associated with a command (e.g., maximum speed at which a movement is to be carried out), or they can be system-level parameters (e.g., total power usage, aspects of system configuration done in software). Further, while some robot-motion parameters are fixed by the manufacturer or integrator, others are reconfigurable by the end user. The parameters fixed by the manufacturer—typically they relate to safety restrictions of performance limits—are preset from the point of view of the integrator and the end user.

In some embodiments, the robot-motion parameters include parameters relating to the maximum, minimum, average or setpoint value of one or more of the following quantities: joint speed, joint acceleration, joint jerk (first time derivative of joint acceleration), joint torque, payload, tool-center-point (TCP) speed, TCP acceleration, electric drive switching frequency, ambient temperature, joint temperature, electric drive power, total drive power of all electric drives in the robot. The ambient-temperature parameter may be a setpoint or maximum value which a robot controller within the industrial robot upholds by controlling air cooling equipment serving the working environment of the industrial robot. The joint-temperature parameter may be a setpoint or maximum value that could trigger a temporary limitation of the robot's work pace and/or the usage of internal or external cooling.

In some embodiments, the robot-motion parameters relate to different joints of the industrial robot. For example, it may be possible to set the maximum joint speed for two or more joints of the industrial robot. The joints may belong to a common kinematic chain (e.g., same robot arm) or different kinematic chains. This is valuable for discovering and controlling undesired interaction between different joints. For example, activity occurring in one joint may excite vibrations in an adjacent joint even though the adjacent joint is currently at rest.

In some embodiments of the present invention, the visualization indicates the acoustic quantity as a function of emission angle. The emission angle may be an azimuthal angle, an elevation angle or a combination of these. These embodiments are particularly useful in unipolar working environments, where the industrial robot is the dominating noise source.

In other embodiments of the present invention, additionally or alternatively hereto, the visualization indicates the acoustic quantity as a function of elapsed execution time of the robot program. Unlike visualizations showing only time-aggregated noise emissions, these embodiments provide the user with time-structured noise information, which makes it possible for the user to correlate different phases of the program with their respective levels of acoustic exposure. In the phases where the noise emissions could harm human hearing, the robot operator may be required to wear various types of personal protective equipment.

Alternatively, it may be possible to adjust the robot program such that the industrial robot needs no operator monitoring in these phases, whereby the operator may be instructed to leave the robot's working environment temporarily.

In a second aspect of the invention, there is provided a method of designing a working environment including an industrial robot and an operator space. A robot developer executing this design method initially runs the noise indication method according to first aspect and uses its output as a basis for locating the operator space in the working environment, that is, in the surroundings of a robot manipulator of the industrial robot. Before deciding on the operator-space localization, the developer is able to study the influence of different robot-motion parameters on the noise emissions. The developer also has the option of running the noise indication method anew with a different set of robot-motion parameter values until an acceptable level of acoustic exposure has been achieved. The method can be generalized to decision-making on the localization of vibration-sensitive equipment, such as fragile machinery or sensors at risk of presenting perturbed results.

In a third aspect of the invention, there is provided a device for performing any of the methods outlined above. The device can for example be a general-purpose computer with a visual display. Corresponding effects and advantages are achieved as for the first and second aspects, and the device can be implemented with a corresponding degree of technical variation.

The invention further relates to a computer program containing instructions for causing a computer, or the above-described device in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 shows an industrial robot deployed in a working environment including two alternative localizations of an operator space and a device for providing noise-emission indications;

FIG. 2 is a flowchart of a computer-implemented noise indication method, which can be embedded in a computer-supported method for designing a working environment with at least one industrial robot;

FIG. 3 depicts a graphical user interface (GUI) displaying a visualization of the noise emissions of an industrial robot as a function of emission angle, for a selectable value of a robot-motion parameter;

FIG. 4 depicts a further GUI displaying multiple contemporaneous noise-emission visualizations of the same type, corresponding to different value of the robot-motion parameter;

FIG. 5 shows an alternative noise-emission visualization suitable for a unipolar working environment; and

FIG. 6 shows a second alternative noise-emission visualization suitable for a multipolar working environment in which multiple robot manipulators are deployed.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description unless otherwise specified.

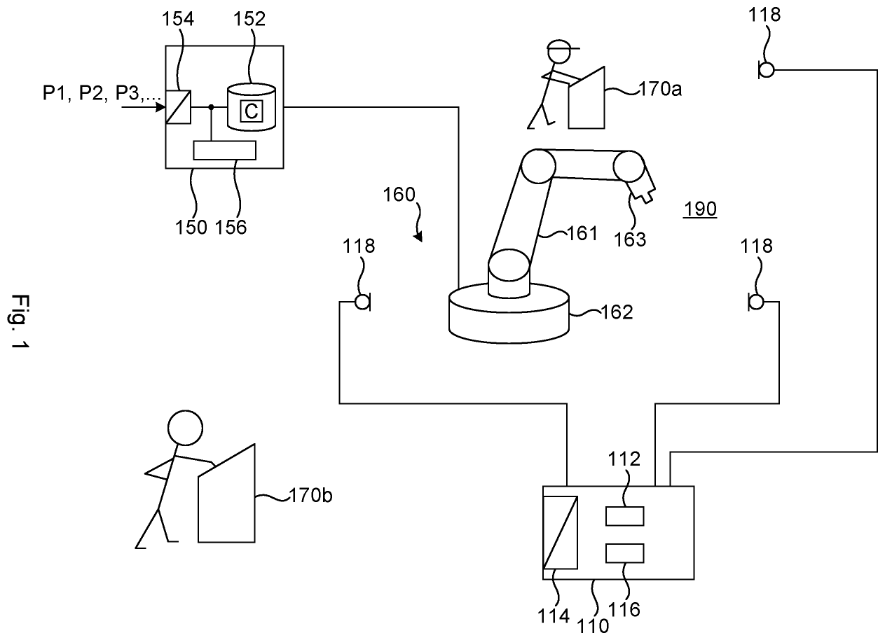

FIG. 1 shows an industrial robot comprising a robot controller 150 and a robot manipulator 160. The robot manipulator 160 is deployed in a working environment 190 that further includes an operator stand, for which two optional localizations are denoted by 170a and 170b. It is assumed that the operator stand must be located somewhere in said working environment 190 (in the interest of good visibility, acceptable intervention time, or the like), and that the extent of the working environment 190 is small enough that noise emissions from the industrial robot must be considered in order to ensure occupational safety and health, including the acoustic exposure of the operator when present. Operator stands, operator cabs, operator desks and operator panels are all examples of operator spaces. In the context of the present disclosure, an operator space could also be an inspection deck or a pedestrian passage that should be safe to use, from the viewpoint of acoustic exposure, while the industrial robot is operating.

The example robot manipulator 160 depicted in FIG. 1 comprises an arm 161 with multiple segments connected by linear or rotary joints, which extends from a base 162 and to which an end effector 163 can be attached. The end effector 163 or its attachment point (not shown) defines a tool center point (TCP) of the manipulator 160. Actuators, drives and other support systems in the robot manipulator 160 are controlled by the robot controller 150. The robot manipulator 160 has a temporary or permanent communicative connection, drawn in solid line, to the robot controller 150 enabling it to exchange measurement signals (generally traveling in the upstream direction) and control signals (generally traveling downstream).

The inner structure of the robot controller 150 can be varied within wide limits and is not essential to the present invention. For example, the robot controller 150 could include a memory 152 suitable for storing robot programs C with robot commands, processing circuitry 156 configured to execute the robot programs C, as well as a data interface 154 operable to accept values of robot-motion parameters P1, P2, P3, . . . which are input by an operator or a processor, or which are received from a remote processor or memory over a local- or wide-area communication network. Furthermore, the values of some of the robot-motion parameters P1, P2, P3, . . . could as well be assigned by way of instructions within one of the robot programs C. The meaning of the terms “command” and “robot-motion parameter” when used in the present disclosure has been discussed above, as well as how they relate to each other. It is recalled that a robot-motion parameter may for example be a maximum, minimum, average or setpoint value of one or more of the following quantities: joint speed, joint acceleration, joint jerk, joint torque, payload, TCP speed, TCP acceleration, electric drive switching frequency, ambient temperature, joint temperature, electric drive power, total drive power of all electric drives in the robot manipulator 160.

Also seen in FIG. 1 is a device 110 for providing visual noise-emission indications. In functional terms, the device comprises a memory 112, a visual display 114 and processing circuitry 116 and is communicatively connected to a plurality of acoustic transducers, here exemplified as microphones 118. The microphones 118 are deployed at different emission angles and/or at different distances from the robot manipulator 160, to be able to capture the robot manipulator's 160 noise emissions with an adequate spatial resolution. As mentioned, the emission angle may have an azimuthal component, an elevation component, or both. Furthermore, in addition to the spatial resolution, the microphones 118 are preferably to be operated for while different values of the robot-motion parameters P1, P2, P3 are in use. It is appreciated that the microphones 118 need not be co-located with the device 110. For one thing, there could be remote connections between the device 110 and the microphones 118 be provided. Furthermore, the microphones 118 could be arranged for offline data capture, wherein the acoustic data is recorded and temporarily stored in a memory (not shown), from which the device 110 retrieves it for processing and/or presentation.

The microphones 118 are but one example of how the noise-emission information can be recorded. In other embodiments of the present invention, the noise-emission information is determined by a computer simulation of the industrial robot. In yet other embodiments, data from past noise recordings (e.g., noise contributions from different joints or actuators in the robot manipulator 160) is used as input to such a computer simulation, which utilizes acoustic and other physical laws to simulate the total noise emission of the robot manipulator 160. The laws could for instance include rules for panning (acoustic summing), phase shifting, reflection, mixing, and attenuation with distance. Specifically, machine learning techniques could be utilized, wherein a model (e.g., neural network) is trained on the basis of recorded noise together with relevant input instructions (commands, robot-motion parameters etc.). The usage of such a trained model may be seen as a hybrid of measurement-based and simulation-based recording of the noise emissions from the industrial robot. It is understood that the results of all three approaches generally provide approximate results, which are a reliable basis for comparing the relative levels of noise emission at different emission angles, different heights etc., but may not correctly reflect absolute values of the acoustic quantities involved, which could have a significant dependence on the quantity of reflecting and absorbing objects in the final setup of the working environment 190.

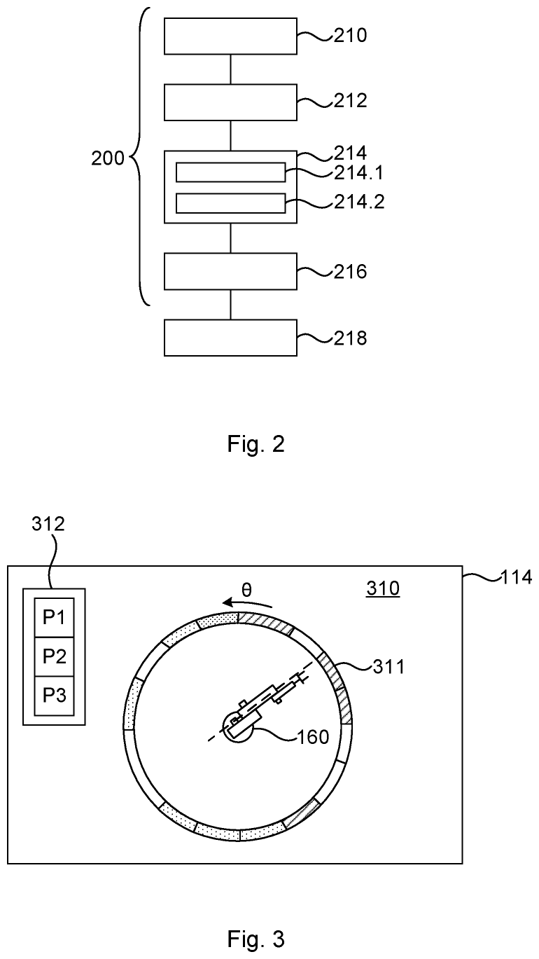

At the focus of the present disclosure, however, is the presentation of the noise-emission information to a user. Particularly valuable use cases have been identified, in which the user is guided by such noise-emission information in a design or integration process relating to the industrial robot, to make more well-informed decisions and/or with reduced time and financial expenditure. This is one of the aims of the method 200, which is shown in flowchart form in FIG. 2. The method 200 can be executed by the device 110 and in respect of the industrial robot 150, 160 depicted in FIG. 1.

In a first step 210 of the method 200, at least one robot program (collectively denoted by C) is obtained, which comprises commands to the industrial robot.

In a second step 212, which may be contemporaneous with the first step 210, a plurality of values of at least one robot-motion parameter P1, P2, P3, . . . is obtained. Accordingly, there is obtained multiple values of a first robot-motion parameter P1 and multiple values of a second robot-motion parameter P2, if a second parameter is in use. Multiple parameters P1, P2, P3, . . . may refer to multiple joints in a common kinematic chain (e.g., same robot arm) or different kinematic chains, whereby resonance, harmonics, overtones and other undesired interaction between different joints can be discovered and controlled. The values may be represented as vectors representing contemporaneous value assignments, wherein a kth component of a vector holds the value for the kth parameter Pk. It is understood that, among the different vectors, the same value can occur multiple times in the same component, whereby the effects of the combined value assignment on the noise emissions can be explored by means of the vectors. In the case of three parameters P1, P2, P3, for each of which the robot controller 150 may accept two different values, a complete set of such assignment vectors may have the following appearance: (10, 1, 90), (20, 1, 90), (10, 2, 90), (20, 2, 90), (10, 2, 95), (20, 2, 95), (10, 1, 95), (20, 1, 95).

In a third step 214 of the method 200, an acoustic quantity is recorded for each of the values (or each of the parameter value combinations, as the case may be) while the industrial robot is executing the obtained robot program(s) C for the relevant robot-motion parameter values. It is optional to add the effect of random factors during the execution and to record the noise resulting from these factors. For example, if the industrial robot has an operator interface, through which the operator can alter the robot settings during the execution, the operator inputs can be sampled as a random process during the recording 214.

The acoustic quantity is indicative of the noise emitted by the industrial robot. Example quantities include frequency spectrum, sound power and sound pressure. Clearly, combinations of these quantities can be used. The acoustic quantity may be recorded in terms of its mean value (e.g., to capture the total acoustic exposure) or maximum value (e.g., to capture isolated, potentially harmful exposure events).

The recording 214 may include performing an acoustic measurement 214.1 of the emitted noise, which is then used on a live or offline basis. The acoustic measurement 214.1 can be made in terms of the acoustic quantity. Alternatively, the recording 214 includes the performing of a computer simulation 214.2 of the noise to be emitted by the robot. Such a computer simulation 214.2 could make reference to data produced by an earlier acoustic measurement on the industrial robot (i.e., a measurement not necessarily coinciding with the acoustic measurement 214.1). In the meantime, the measurement data may be deposited in a data store, database and/or a static look-up table relating combinations of the robot program and robot-motion parameter values to the emitted noise. The consultation of a trained machine-learning model is also to be regarded as a reference to data from an earlier acoustic measurement in the sense of the claims. The earlier acoustic measurement may have been performed for the same industrial robot as the one for which the method 200 is being executed. However, the earlier measurement can as well have been performed for a different robot of the same model, or a different robot which shares relevant structural and dynamical features, such as actuator types, motor types, gear types, joint types, end effectors, tools, energy sources etc. This approach is particularly valuable if the industrial robot has a modular structure, e.g., it has been assembled from pre-designed or pre-assessed components, which provide known contributions to the total noise emission for a given command and a given parameter value assignment.

In a next step 216 of the method 200, a visualization 311 of the acoustic quantity is displayed using a graphical user interface (GUI) 310, e.g., on the visual display 114 of the device 110. The visualization 311 indicates the acoustic quantity as a function of the robot-motion parameter. Example appearances of such visualizations 311 are shown in FIGS. 3 to 6 and will be discussed below.

Optionally, the visualization 310 displayed in step 216 may further indicate the acoustic quantity as a function of the noise emission angle θ. The emission angle is defined relative to a reference point on the robot manipulator 160 of the industrial robot. The emission angle θ may have an azimuthal and/or an elevation component.

Further optionally, the visualization 310 may indicate the acoustic quantity as a function of elapsed execution time. The execution time may be counted from the start of the execution of the robot program C. By seeing the emitted noise as a function of the elapsed execution time in the visualization 310, the user (e.g., a robot designer or integrator) will be able to differentiate various phases of the robot program C with respect to the average exposure and/or the presence of potentially harmful events, on which basis the user may propose suitable protective measures for protecting the operator and/or that the operator shall be advised to leave the working environment 190 temporarily. The fineness of the division into robot-program phases can vary between different embodiments. The division may follow the succession of manufacturing or processing tasks in the program C (e.g., welding, screwing, drilling), wherein the noise emissions can be assumed to be uniform within each task. Another option is to divide the execution time into subintervals of equal length and visualize the average or maximum of the acoustic quantity within each subinterval.

An optional step 218 may be appended to the method 200, in which it is decided where to locate the operator space 170 relative to the industrial robot in the working environment 190. As an output of the preceding steps, the decision-maker (e.g., robot designer or robot integrator) will have a good understanding of the robot's noise emissions and may then be able to locate the operator space 170 where the operator will experience limited or harmless acoustic exposure. The localization may consider further aspects in addition to the noise exposure, such as the accessibility of various areas of the working environment 190, the ease of recurrent logistic movements (e.g., refilling, cleaning, servicing), acceptable safety distances from electric circuits, rotating machinery etc. The step 218 may also include deciding to install acoustic absorbents or reflectors that could further improve the acoustic conditions in the operator space 170; the success of such protective measures may need to be confirmed by acoustic measurements on site.

FIG. 3 depicts a GUI 310 on the visual display 114 which includes a ring-shaped visualization 311 of the noise emissions of an industrial robot as a function of emission angle θ. The different shadings of the sectors correspond to different value intervals of the acoustic quantity. The GUI 310 includes a selector 312 allowing the user to toggle between said sub-visualizations for selectable values (or selectable value combinations) of the robot-motion parameters P1, P2, P3. For example, the selector 312 seen in FIG. 3 may be configured such that the button labeled “P1” opens a drop-down menu from which the user selects a desired value of parameter P1. Similar drop-down menus may open from the further buttons “P2”, “P3”. When the user selects a new parameter value combination, the shadings of the sectors of the ring-shaped visualization 311 change visibly if the noise emissions are different.

The GUI 310 in FIG. 3 can optionally be provided with a further selector, by which the user can toggle between different height values. This way, the user can inspect the noise emission's dependence on height, which may be valuable from the viewpoint of occupational safety and health. Clearly, noise emissions creating an acoustic exposure at the level of operators' ears should be of more immediate concern than, say, vertical noise emissions. Noise-emission information structured with respect to height can be obtained by means multiple microphones 118 (FIG. 1) arranged at different heights.

As an alternative to what is illustrated in FIG. 3, the GUI 310 could include a combination selector, by which the user can toggle between pre-specified combinations of parameter values. For example, the toggling can occur between the six vectors in the following set: (20, 1, 90), (10, 2, 90), (20, 2, 90), (10, 2, 95), (20, 2, 95), (10, 1, 95). It is seen that not all parameter values can be combined freely, e.g., because there are gaps for which no noise emission information has been recorded. Hence, it may be more informative for the user to see these gaps at the outset, rather than trying in vain to set an undefined value combination using the selector 312 of FIG. 3.

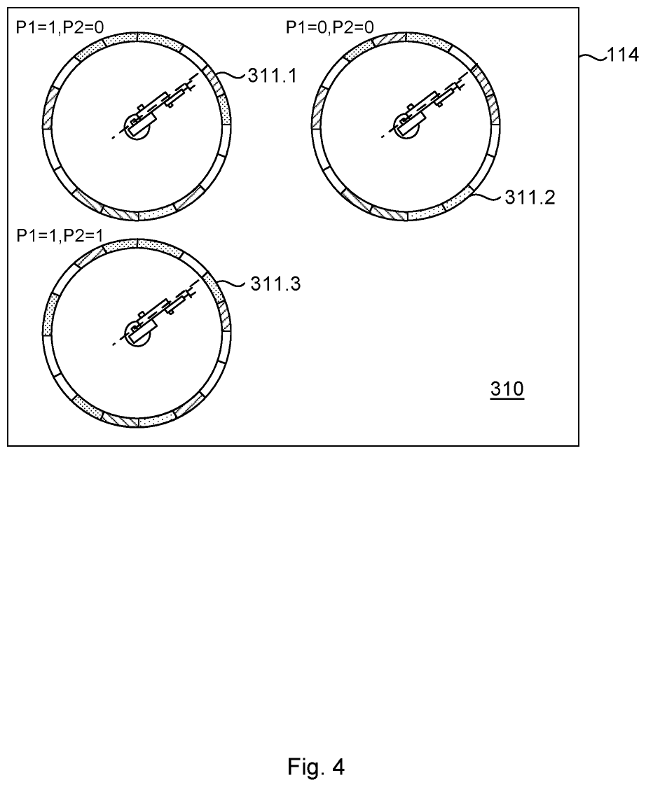

FIG. 4 depicts a further GUI 310, which includes three contemporaneous ring-shaped visualizations 311.1, 311.2, 311.3 of the noise emissions of the industrial robot as a function of emission angle θ. For each visualization 311, a corresponding assignment of values to two robot-motion parameters P1, P2 is shown in the upper left corner. It is seen that the shading of the sectors, corresponding to different values of the acoustic quantity, differs between all visualizations 311.1, 311.2, 311.3. A GUI 310 of this type could give the user a useful panoramic view of the variability of the noise as a function of the robot-motion parameter.

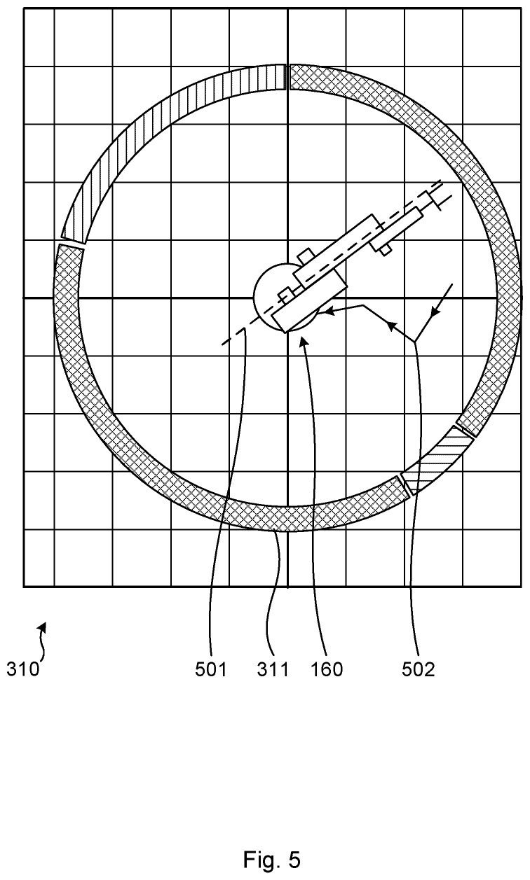

FIG. 5 shows a GUI 310 with an alternative noise-emission visualization 311 suitable for a unipolar working environment, that is, an environment which is centered at the attachment point of a robot manipulator 160. This GUI 310 is annotated with auxiliary information including a horizontal grid, a current main axis 501 of the robot manipulator 160 and a motion path 502 defined by the robot program C. As previously, the visualization 311 may be one in a toggleable set of visualizations or one in a set of contemporaneously displayed visualizations corresponding to different (combinations of) values assigned to robot-motion parameters P1, P2, P3, P4, P5, P6, . . . .

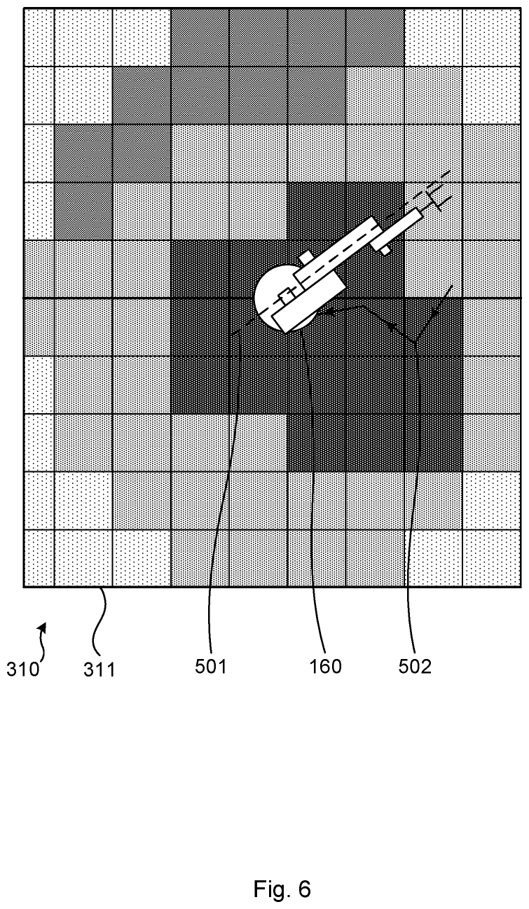

FIG. 6 shows a still further GUI 310 with a visualization 311 suitable for a multipolar working environment. In a multipolar working environment, further machinery and/or further robot manipulators (not shown in FIG. 6) are deployed in addition to the robot manipulator 160 and constitute further potential noise sources. Such a working environment may not lend itself to the polar representation according to FIGS. 3 to 5, where the noise emissions are indicated as functions of an emission angle θ. Instead, the noise emissions are indicated for each cell of the horizontal grid by applying corresponding shading.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method of indicating noise emissions of an industrial robot, comprising:
obtaining at least one robot program containing commands to the industrial robot;
obtaining a plurality of values of at least one robot-motion parameter;
recording, for each of the values of the robot-motion parameter, an acoustic quantity indicative of noise emitted by the industrial robot while executing said at least one robot program; and
displaying, by means of a graphical user interface, a visualization of the acoustic quantity,
characterized in that the visualization indicates the acoustic quantity as a function of the robot-motion parameter.

2. The method of claim 1, wherein the at least one robot-motion parameter includes one or more of: joint speed, joint jerk, joint acceleration, joint torque, payload, TCP speed, TCP acceleration, drive switching frequency, ambient temperature, joint temperature, drive power.

3. The method of claim 1, wherein values are obtained for multiple robot-motion parameters relating to different joints of the industrial robot.

4. The method of claim 1, wherein the visualization includes multiple contemporaneous sub-visualizations for respective values of the robot-motion parameter.

5. The method of claim 1, wherein the visualization includes multiple sub-visualizations for respective values of the robot-motion parameter, and the graphical user interface includes a selector allowing a user to toggle between said sub-visualizations.

6. The method of claim 1, wherein the visualization indicates the acoustic quantity as a function of emission angle.

7. The method of claim 1, wherein the visualization indicates the acoustic quantity as a function of elapsed execution time.

8. The method of claim 1, wherein said recording includes performing an acoustic measurement and/or performing a computer simulation of the emitted noise.

9. The method of claim 8, wherein said recording includes performing a computer simulation of the emitted noise, the computer simulation making reference to data from at least one earlier acoustic measurement on the industrial robot.

10. The method of claim 1, wherein the acoustic quantity is one or more of: frequency spectrum, sound power, sound pressure.

11. A method of designing a working environment including an industrial robot and an operator space, the method comprising:
indicating noise emissions of an industrial robot, including:
obtaining at least one robot program containing commands to the industrial robot;
obtaining a plurality of values of at least one robot-motion parameter;
recording, for each of the values of the robot-motion parameter, an acoustic quantity indicative of noise emitted by the industrial robot while executing said at least one robot program; and
displaying, by means of a graphical user interface, a visualization of the acoustic quantity,
characterized in that the visualization indicates the acoustic quantity as a function of the robot-motion parameter, to obtain an indication of the industrial robot's noise emissions; and
locating the operator space relative to the industrial robot on the basis of said indication.

12. A device comprising memory, a visual display and processing circuitry configured to perform the method of indicating noise emissions of an industrial robot, including:
obtaining at least one robot program containing commands to the industrial robot;
obtaining a plurality of values of at least one robot-motion parameter;
recording, for each of the values of the robot-motion parameter, an acoustic quantity indicative of noise emitted by the industrial robot while executing said at least one robot program; and
displaying, by means of a graphical user interface, a visualization of the acoustic quantity,
characterized in that the visualization indicates the acoustic quantity as a function of the robot-motion parameter.

13. A computer program comprising instructions to cause the device having memory, a visual display and processing circuitry configured to perform the method of indicating noise emissions of an industrial robot, including:
obtaining at least one robot program containing commands to the industrial robot;
obtaining a plurality of values of at least one robot-motion parameter;
recording, for each of the values of the robot-motion parameter, an acoustic quantity indicative of noise emitted by the industrial robot while executing said at least one robot program; and
displaying, by means of a graphical user interface, a visualization of the acoustic quantity,
characterized in that the visualization indicates the acoustic quantity as a function of the robot-motion parameter.

14. The method of claim 2, wherein values are obtained for multiple robot-motion parameters relating to different joints of the industrial robot.

15. The method of claim 2, wherein the visualization includes multiple contemporaneous sub-visualizations for respective values of the robot-motion parameter.

16. The method of claim 2, wherein the visualization includes multiple sub-visualizations for respective values of the robot-motion parameter, and the graphical user interface includes a selector allowing a user to toggle between said sub-visualizations.

17. The method of claim 2, wherein the visualization indicates the acoustic quantity as a function of emission angle.

18. The method of claim 2, wherein the visualization indicates the acoustic quantity as a function of elapsed execution time.

19. The method of claim 2, wherein said recording includes performing an acoustic measurement and/or performing a computer simulation of the emitted noise.

20. The method of claim 2, wherein the acoustic quantity is one or more of: frequency spectrum, sound power, sound pressure.
